(19) United States
(12) Patent Application Publication
(10) Pub. No.: US 2020/0166126 A1
(43) Pub. Date: May 28, 2020

(54) REAL TIME SUPERVISED MACHINE LEARNING TORQUE CONVERTER MODEL

(71) Applicant: GM GLOBAL TECHNOLOGY OPERATIONS LLC, Detroit, MI (US)

(72) Inventors: Bryan P. Jagielo, Wixom, MI (US); Jose C. Zavala Jurado, Ann Arbor, MI (US)

(21) Appl. No.: 16/201,306

(22) Filed: Nov. 27, 2018

(51) Int. Cl. F16H 61/14

(52) U.S. Cl. CPC F16H 61/143; F16H 2059/366

(57) ABSTRACT

A vehicle, control system for operating a torque converter of a vehicle and a method of operating a torque converter. The control system includes a machine learning model and a model-based controller. The machine learning model is configured to receive a first set of measurements of operational parameters of the torque converter, and determine fit parameters for a model of the torque converter using the first set of measurements. The model-based controller is configured to receive a second set of measurements of operational parameters of the torque converter, determine a clutch pressure for the torque converter from the second set of measurements and the fit parameters, and apply the determined clutch pressure to the torque converter.

### INTRODUCTION

The subject disclosure relates to operating a torque converter of a vehicle and, in particular, to forming a model of operation of the torque converter and controlling a pressure applied to a clutch of the torque converter based on operational parameters of the torque converter and the model.

A torque converter is used to transfer torque from an engine of a vehicle to a transmission of the vehicle through hydraulic transmission methods. Current torque converter models are not able to capture variations in both operational parameters of the torque converter and pressure at a clutch of the torque converter. These models also require time in order to be calibrated. Accordingly, it is desirable to provide a torque converter model that can learn from operational parameters and clutch pressures in real-time in order to determine and apply suitable pressures at the clutch of the torque converter.

### SUMMARY

In one exemplary embodiment, a method of operating a torque converter is disclosed. A first set of measurements of operational parameters of the torque converter is obtained. Fit parameters are determined for a model of the torque converter using the first set of measurements. A second set of measurements of operational parameters of the torque converter is obtained. A clutch pressure is determined for the torque converter from the second set of measurements and the fit parameters. The determined clutch pressure is applied to the torque converter.

In addition to one or more of the features described herein, determining the fit parameters further includes applying a recursive least squares fitting to the first set of measurements. The method further includes receiving the first set of measurements at a machine learning system that determines the fit parameters, and receiving the second set of measurements at a model-based controller that determines and applies the clutch pressure. The method further includes modeling the clutch pressure as a linear combination of the operational parameters. The method further includes determining a controlling sub-region of operation of the torque converter and selecting at least the first set of measurements from the controlling sub-region. The operational parameters include an operational parameter of the engine and an operational parameter of the turbine. The operational parameters can include at least one of a turbine speed, an engine speed, a clutch torque gain, a clutch friction compensation term, and a clutch pressure offset.

In another exemplary embodiment, a control system for operating a torque converter of a vehicle is disclosed. The control system includes a machine learning model and a model-based controller. The machine learning model is configured to receive a first set of measurements of operational parameters of the torque converter, and determine fit parameters for a model of the torque converter using the first set of measurements. The model-based controller is configured to receive a second set of measurements of operational parameters of the torque converter, determine a clutch pressure for the torque converter from the second set of measurements and the fit parameters, and apply the determined clutch pressure to the torque converter.

In addition to one or more of the features described herein, the machine learning model is configured to apply a recursive least squares fitting to the first set of measurements to determine the fit parameters. The machine learning model is further configured to model the clutch pressure as a linear combination of the operational parameters. The control system further includes a supervisor configured to determine a controlling sub-region of operation of the torque converter and select at least the first set of measurements from the controlling sub-region. The operational parameters include an operational parameter of the engine and an operational parameter of the turbine. The operational parameters can include at least one of a turbine speed, an engine speed, a clutch torque gain, a clutch friction compensation term, and a clutch pressure offset.

In yet another exemplary embodiment, a vehicle is disclosed. The vehicle includes a torque converter and a control system. The control system is configured to obtain a first set of measurements of operational parameters of the torque converter, determine fit parameters for a model of the torque converter using the first set of measurements, obtain a second set of measurements of operational parameters of the torque converter, determine a clutch pressure for the torque converter from the second set of measurements and the fit parameters, and apply the determined clutch pressure to the torque converter.

In addition to one or more of the features described herein, the control system includes a machine learning model configured to receive the first set of measurements and determine the fit parameters, and a model-based controller configured to receive the second set of measurements, determine the clutch pressure and apply the determined clutch pressure to the torque converter. The machine learning model is configured to apply a recursive least squares fitting to the first set of measurements to determine the fit parameters. The machine learning model is further configured to model the clutch pressure as a linear combination of the operational parameters. The control system further includes a supervisor configured to determine a controlling sub-region of operation of the torque converter and select at least the first set of measurements from the controlling sub-region. The operational parameters include an operational parameter of the engine and an operational parameter of the turbine. The operational parameters can include at least one of a turbine speed, an engine speed, a clutch torque gain, a clutch friction compensation term, and a clutch pressure offset.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 schematically depicts a vehicle operable using a torque converter control system;

FIG. 2 shows a cross-sectional side view of an illustrative torque converter of FIG. 1;

FIG. 3 shows a schematic diagram of a torque converter system that includes the torque converter and control system;

FIG. 4 shows convergence plots for the various fit parameters of the torque converter model, illustrating the convergence of the fit parameters over several iterations.

FIG. 5 shows a plot comparing predicted pressure values vs. actual pressure values.

FIG. 6 shows a diagram illustrating various operating regions of the torque converter; and

FIG. 7 shows a flowchart illustrating a method for operating a torque converter using the model disclosed herein.

### DETAILED DESCRIPTION

The following description is merely exemplary in nature and is not intended to limit the present disclosure, its application or uses. It should be understood that throughout the drawings, corresponding reference numerals indicate like or corresponding parts and features.

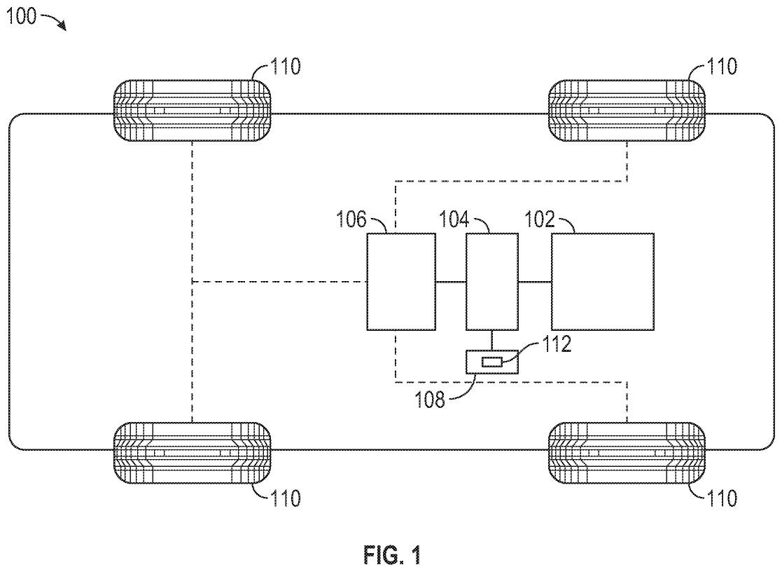

In accordance with an exemplary embodiment, FIG. 1 schematically depicts a vehicle 100 operable using a torque converter control system. The vehicle includes an engine 102, a torque converter 104 and a transmission 106. The torque converter 104 converts torque provided by the engine at an engine speed to a torque usable at the transmission 106 in order to operate wheels 110 of the vehicle. Such torque conversion controls the transfer of rotary motion from the engine 102 to the transmission 106. A control system 108 for the torque converter 104 includes a processor 112 that obtains measurements from various sensors at the torque converter and controls the operation of the torque converter based on these measurements, as discussed below.

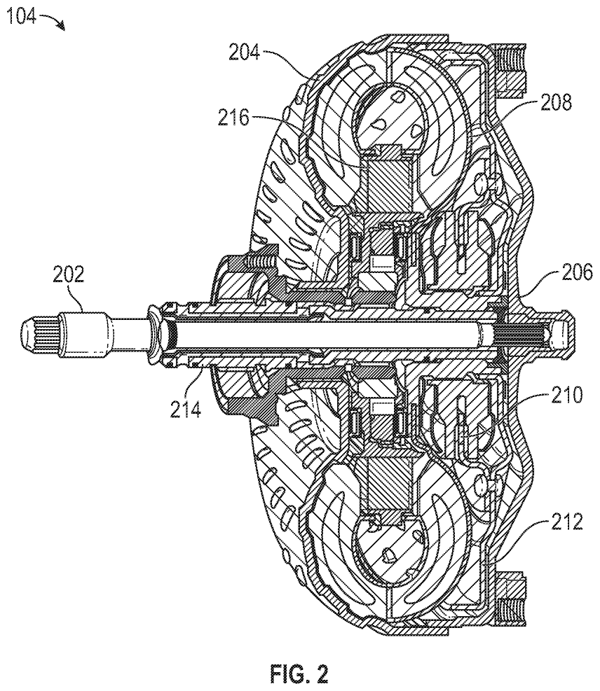

FIG. 2 shows a cross-sectional side view of an illustrative torque converter 104 of FIG. 1. The torque converter 104 includes various components that are coupled to the engine 102, FIG. 1 and various components coupled to the transmission 106, FIG. 1. Components coupled to the engine 102 include a drive shaft 202, pump 204 and cover 206. Components coupled to the transmission 106, FIG. 1 include turbine 208, damper assembly 210, clutch assembly 212 and turbine shaft 214. A stator 216 is a grounded component of the torque converter 104 that is not coupled to either the engine 102 or the transmission 106. The stator 216 can be useful to facilitate fluid flow between the turbine 208 and pump 204 in order to control torque transfer between pump 204 and turbine 208.

The pump 204 and turbine 208 are separate components that rotate within a fluid-filled cavity formed by cover 206. The pump 204 rotates to cause a circulation of the fluid in the cavity. The circulating fluid causes the turbine 208 to rotate, thereby transferring rotary motion from the pump 204 to the turbine 208. The drive shaft 202 is coupled to the pump 204 and transfers a rotation of the engine to a rotation of the pump 204. Similarly, the turbine shaft 214 is coupled to turbine 208 and transfers the rotation of the turbine 208 to a rotation of the transmission 106, FIG. 1. Thus, in order to transfer power from the engine to the transmission, the engine rotates the drive shaft 202 to rotate pump 204 in order to cause circulation of the fluid in the cavity, with the circulation of the fluid causing the rotation of turbine 208 and turbine shaft 214. Clutch assembly 212 and damper assembly 210 control a relative axial proximity of the pump 204 to the turbine shaft 214, thereby controlling the torque coupling between pump 204 and turbine shaft 214. This proximity can be controlled by applying a torque converter clutch pressure or “clutch pressure,” P_{TCC}.

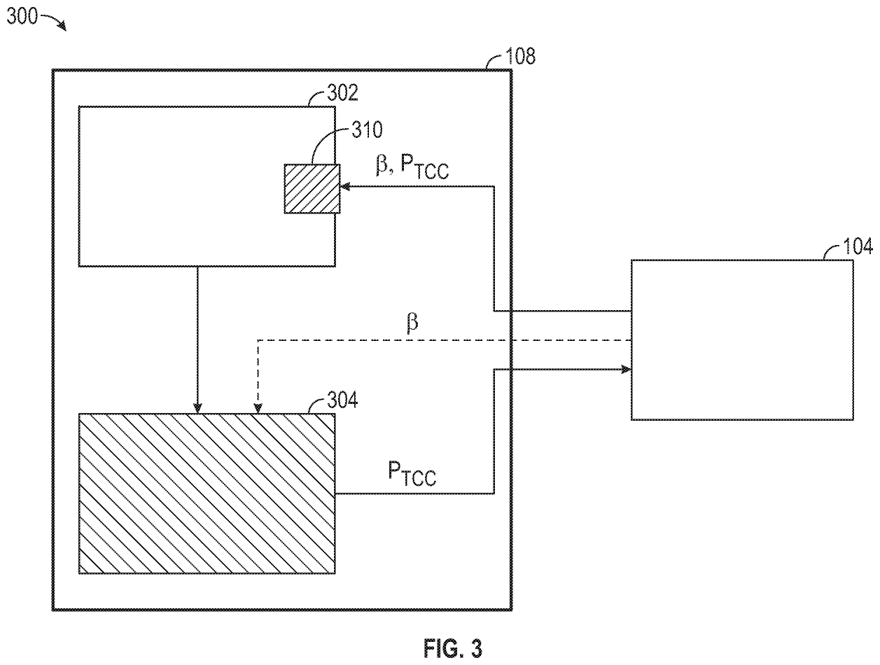

FIG. 3 shows a schematic diagram of a torque converter system 300 that includes the torque converter 104 and control system 108. The control system includes a machine learning system 302 for forming a model of operation of the torque converter 104 based on various measurements from the torque converter 104 and a model-based controller 304 that operates the torque converter 104 based on the model. The control system 108 operates the machine learning system 302 and the model-based controller 304. Various sensors (not shown) of the torque converter 104 provide measurements to the machine learning system 302. Exemplary measurements include a turbine rotational speed ω_{Turb}, an engine rotational speed ω_{Eng}, clutch torque gain τ_{Eng}, a clutch friction compensation term ω_{TCC} and the clutch pressure P_{TCC}. The machine learning system 302 forms a model of the torque converter 104 from these measurements and provides the model to the model-based controller 304. The model-based controller 304 uses the model in order to determine a torque converter clutch pressure P_{TCC} that achieves a selected torque conversion and applies the determined clutch pressure P_{TCC} to the clutch of the torque converter 104.

In various embodiments, the machine learning system 302 forms a model of the torque converter 104 that relates clutch pressure P_{TCC} to the operational parameters of the torque converter, as shown below in Eq. (1):

P_{TCC}=βx=a₁ω_{Turb}²+a₂ω_{Turb}ω_{Eng}+a₃ω_{Eng}²+a₄τ_{Eng}+a₅ω_{TCC}+a₆ Eq. (1)

where

β=[ω_{Turb}²ω_{Turb}ω_{Eng}ω_{Eng}²τ_{Eng}ω_{TCC}1] Eq. (2)

represents measured operational parameters of the torque converter 104. The first three values of the β vector of Eq. (2) (i.e., ω_{Turb}², ω_{Turb}ω_{Eng}, and ω_{Eng}²) are hydraulic parameters of the torque converter 104. Engine torque τ_{Eng} signifies a generalized clutch gain and ω_{TCC} indicates a friction curve compensation at the clutch 212. The vector x of Eq. (1) include fit parameters or fit coefficients associated with the operational parameters of the torque converter 104, as shown in Eq. (3):

x^{T}=[a₁a₂a₃a₄a₅a₆] Eq. (3)

The machine learning system 302 determines these fit parameters of the x vector and provides the determined fit parameters from the machine learning system 302 to the model-based controller 304. The model-based controller 304 then determines a clutch pressure P_{TCC} by measuring the operational parameters of rotational speed ω_{Turb}, engine rotational speed ω_{Eng}, clutch torque gain τ_{Eng}, and clutch friction compensation term ω_{TCC}, and suppling these operational parameters to the model as established by the determined fit parameters. The model-based controller 304 then applies this clutch press P_{TCC} to the clutch 212 of the torque converter 104.

The discussion below with respect to Eqs. (4)-(15) describes determining the fit parameters of the torque converter model using recursive least squares operation. At the machine learning system 302, N measurements are made of the operational parameters of the torque converter 104. Given N measurements, Eq. (1) can be written as an N-dimensional model:

β_{N}x=P_{TCC}^{(N)} Eq. (4)

The model of Eq. (4) can be solved in order to determine the fit parameters x by treating the model as a linear system: The linear system of Eq. (4) is in the form:

Ax=b Eq. (5)

where A represents the matrix β_{N} and b represent the vector P_{TCC}^{(N)}. The solution of this matrix equation can be determined by minimizing the equation:

∥AX−b∥ Eq (6)

which can be minimized by evaluating:

x*=(A^{T}A)⁻¹A^{T}b Eq. (7)

In terms of determining the fit parameters for the torque converter 104, N measurements of the operational parameters for the torque converter 104 can be used to determine initialized values of the operational parameters:

$${A}_{0} = [ \begin{matrix}{β}_{k - N} \\ {β}_{k - N + 1} \\ ⋮ \\ {β}_{k - 1}\end{matrix} ] \qquad Eq . ( 8 )$$

and of the corresponding clutch pressures:

$${b}_{0} = [ \begin{matrix}{P}_{TCC}^{( k - N )} \\ {P}_{TCC}^{( k - N + 1 )} \\ ⋮ \\ {P}_{TCC}^{( k - 1 )}\end{matrix} ] \qquad Eq . ( 9 )$$

where A₀ and b₀ are initial variables of the linear equation of Eq. (5):

Aₖ=βₖ=[ω_{Turb}²ω_{Turb}ω_{Eng}ω_{Eng}²τ_{Eng}ω_{TCC}1] Eq. (10)

and

bₖ=P_{TCC}^{(k)} Eq. (11)

are the kth values of the operational parameters of Eq. (5). Once the N measurements have been obtained, it is possible to form the initial matrix A₀ and initial vector b₀. An initial value x₀ for the fit parameters can be determined from the calculations of Eqs. (12) and (13):

P₀=(A₀^{T}A₀)⁻¹ Eq. (12)

and

x₀=P₀A₀^{T}b₀ Eq. (13).

An iteration process is used to update the fit parameters with each iteration or new set of operational parameter data. At the k^{th} iteration, the fit parameters can be updated based on initial values (of Eqs. (8) and (9)) and the k^{th} measurements (of Eqs. (10) and (11)), as shown below in Eqs. (14) and (15):

$$\begin{matrix}{P}_{k} = {P}_{0} - \frac{{P}_{0} {A}_{k}^{T} {A}_{k} {P}_{0}}{1 + {A}_{k} {P}_{0} {A}_{k}^{T}} \\ and & Eq . ( 14 ) \\ {x}_{k} = {x}_{0} + {P}_{k} {A}_{k}^{T} ( {b}_{0} - {A}_{k} {x}_{0} ) . & Eq . ( 15 )\end{matrix}$$

As the number of measurements increases, and thus the number of iterations, the fit parameters converge to given values.

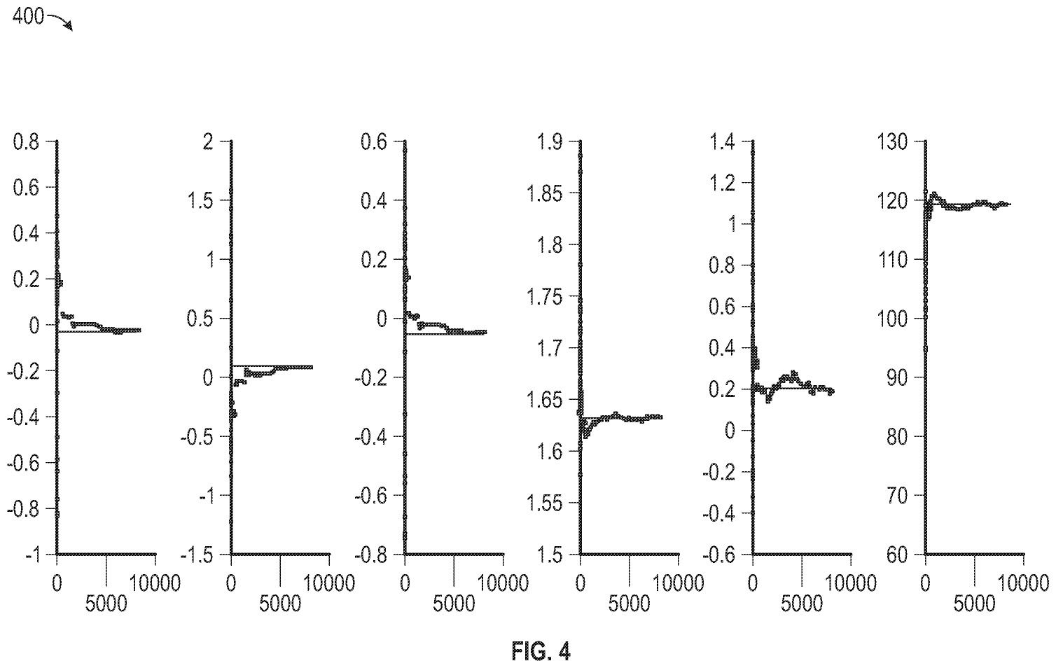

FIG. 4 shows convergence plots 400 for the various fit parameters of the torque converter model, illustrating the convergence of the fit parameters over several iterations. Convergence for the fit parameters (a1, a2, a3, a4, a5, a6) for the five operational parameters (ω_{Turb}², ω_{Turb}ω_{Eng}, ω_{Eng}², τ_{Eng}ω_{TCC}) and clutch offset pressure are displayed. Suitable convergence can be determined in less than 1000 iteration for all of the fit parameters, with some of the fit parameters converging fewer iterations.

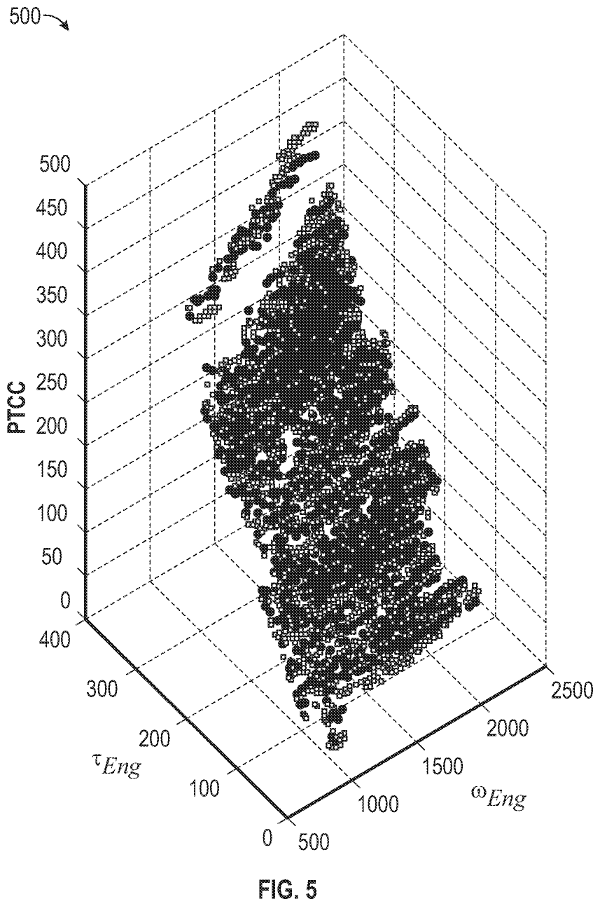

FIG. 5 shows a plot 500 comparing predicted pressure values vs. actual pressure values. These values are plotted against engine torque and turbine speed. The predicted pressure values show good agreement with actual pressure values.

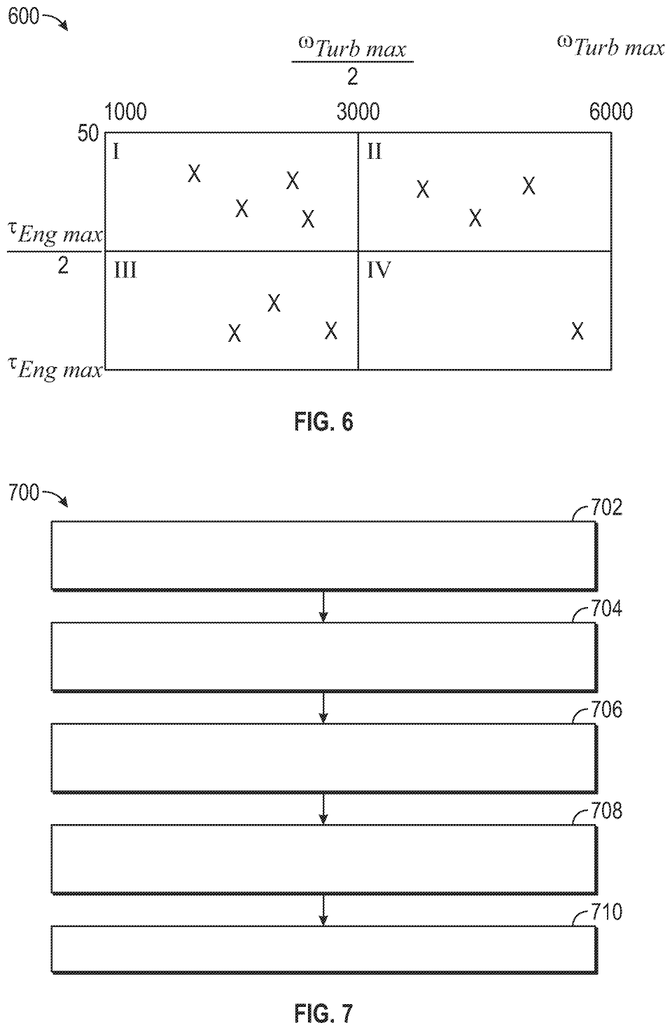

FIG. 6 shows a diagram 600 illustrating various operating regions of the torque converter 104. The diagram 600 shows a two-dimensional map of an operating region defined along the x-axis by turbine rotational speed ω_{Turb} and along the y-axis by engine torque τ_{Eng}. Four sub-regions are shown, labelled I, II, III and IV. Data points are shown accumulated within each of the four sub-regions. Sub-region I shows an accumulation of four counts, sub-region II shows an accumulation of three counts, sub-region III shows an accumulation of three counts and sub-region IV shows an accumulation of 1 count.

In various embodiments the torque converter 104 tends to operate within one of these operating sub-regions more than in the others. The sub-region having most accumulations can be a controlling sub-region of operation. Thus, the machine learning system 302 is facilitated by determining the controlling sub-region of operation of the torque converter 104 and determining PTCC for the controlling sub-region of operation based on the measurements corresponding to the controlling sub-region.

In various embodiments, a supervisor 310 of the machine learning system 302 maintains a count of the accumulations to determine a controlling sub-region of operation of the torque converter 104. The count can be a running count of the N most recent data points, for example. The supervisor 310 provides the data points from the controlling sub-region of operation in order to determine the PTCC. The supervisor 310 can prevent the machine learning system 302 from receiving singularity values. The supervisor 310 can also obtain a suitable distribution of data points for use at the machine learning system 302.

FIG. 7 shows a flowchart illustrating a method 700 for operating a torque converter using the model disclosed herein. In box 702, a first set of measurements of operational parameters of the torque converter are obtained at the machine learning system 302. In box 704, the machine learning system 302 creates a model for operation of the torque converter, determining a set of fit parameters for the operational parameters. In box 706, a second set of measurements of operational parameters are obtained at model-based controller 304. In box 708, the model based controller 304 determines a clutch pressure PTCC based on the second set of measurements and the model or the fit parameters of the model. In box 710, the model-based controller 304 applies the determined clutch pressure to the torque converter.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method of operating a torque converter, comprising:
obtaining a first set of measurements of operational parameters of the torque converter;
determining fit parameters for a model of the torque converter using the first set of measurements;
obtaining a second set of measurements of operational parameters of the torque converter;
determining a clutch pressure for the torque converter from the second set of measurements and the fit parameters;
applying the determined clutch pressure to the torque converter.

2. The method of claim 1, wherein determining the fit parameters further comprises applying a recursive least squares fitting to the first set of measurements.

3. The method of claim 1, further comprising receiving the first set of measurements at a machine learning system that determines the fit parameters, and receiving the second set of measurements at a model-based controller that determines and applies the clutch pressure.

4. The method of claim 1, further comprising modeling the clutch pressure as a linear combination of the operational parameters.

5. The method of claim 1, further comprising determining a controlling sub-region of operation of the torque converter and selecting at least the first set of measurements from the controlling sub-region.

6. The method of claim 1, wherein the operational parameters include an operational parameter of the engine and an operational parameter of the turbine.

7. The method of claim 1, wherein the operational parameters include at least one of: (i) a turbine speed; (ii) an engine speed; (iii) a clutch torque gain; (iv) a clutch friction compensation term; and (v) a clutch pressure offset.

8. A control system for operating a torque converter of a vehicle, comprising:
a machine learning model configured to:
receive a first set of measurements of operational parameters of the torque converter; and
determine fit parameters for a model of the torque converter using the first set of measurements; and
a model-based controller configured to;
receive a second set of measurements of operational parameters of the torque converter;
determine a clutch pressure for the torque converter from the second set of measurements and the fit parameters; and
apply the determined clutch pressure to the torque converter.

9. The control system of claim 8, wherein the machine learning model is configured to apply a recursive least squares fitting to the first set of measurements to determine the fit parameters.

10. The control system of claim 8, wherein the machine learning model is further configured to model the clutch pressure as a linear combination of the operational parameters.

11. The control system of claim 8, further comprising a supervisor configured to determine a controlling sub-region of operation of the torque converter and select at least the first set of measurements from the controlling sub-region.

12. The control system of claim 8, wherein the operational parameters include an operational parameter of the engine and an operational parameter of the turbine.

13. The control system of claim 8, wherein the operational parameters include at least one of: (i) a turbine speed; (ii) an engine speed; (iii) a clutch torque gain; (iv) a clutch friction compensation term; and (v) a clutch pressure offset.

14. A vehicle system, comprising:
a torque converter;
a control system configured to:
obtain a first set of measurements of operational parameters of the torque converter;
determine fit parameters for a model of the torque converter using the first set of measurements;
obtain a second set of measurements of operational parameters of the torque converter;
determine a clutch pressure for the torque converter from the second set of measurements and the fit parameters; and
apply the determined clutch pressure to the torque converter.

15. The vehicle system of claim 14, wherein the control system includes a machine learning model configured to receive the first set of measurements and determine the fit parameters, and a model-based controller configured to receive the second set of measurements, determine the clutch pressure and apply the determined clutch pressure to the torque converter.

16. The vehicle system of claim 15, wherein the machine learning model is configured to apply a recursive least squares fitting to the first set of measurements to determine the fit parameters.

17. The vehicle system of claim 15, wherein the machine learning model is further configured to model the clutch pressure as a linear combination of the operational parameters.

18. The vehicle system of claim 15, wherein the control system further includes a supervisor configured to determine a controlling sub-region of operation of the torque converter and select at least the first set of measurements from the controlling sub-region.

19. The vehicle system of claim 14, wherein the operational parameters include an operational parameter of the engine and an operational parameter of the turbine.

20. The vehicle system of claim 14, wherein the operational parameters include at least one of: (i) a turbine speed; (ii) an engine speed; (iii) a clutch torque gain; (iv) a clutch friction compensation term; and (v) a clutch pressure offset.
